(19) United States
(12) Patent Application Publication
(10) Pub. No.: US 2022/0159441 A1
(43) Pub. Date: May 19, 2022

(54) SYSTEM AND METHOD THEREFOR

(71) Applicant: NEC Corporation, Minato-ku, Tokyo (JP)

(72) Inventor: Hiroaki AMINAKA, Tokyo (JP)

(73) Assignee: NEC Corporation, Minato-ku, Tokyo (JP)

(21) Appl. No.: 17/439,479

(22) PCT Filed: Dec. 6, 2019
(86) PCT No.: PCT/JP2019/047726

§ 371 Date: Sep. 15, 2021

(30) Foreign Application Priority Data
Mar. 22, 2019 (JP) 2019-055092

(51) Int. Cl. H04W 4/90; H04W 28/24; H04W 4/10; H04L 65/10

(52) U.S. Cl. CPC H04W 4/90; H04L 65/1006; H04W 4/10; H04W 28/24

(57) ABSTRACT

At least one server (11) communicates with one or more applications running on each of wireless terminals (2) through one or more communication paths provided by a cellular communication network (3). The at least one server (11) determines a QoS parameter to be applied by the cellular communication network (3) to each communication path, based on one or any combination of a priority associated with each application, a priority associated with each wireless terminal (2), and a priority associated with an organization to which the wireless terminals (2) belong. The at least one server (11) communicates with a node in the cellular communication network (3) to enforce the determined QoS parameter on the corresponding communication path. This, for example, allows priority handling regarding a public safety service to be reflected in a QoS parameter of a cellular communication network.

### TECHNICAL FIELD

The present disclosure relates to wireless communication and, in particular, to priority control in a cellular communication network.

### BACKGROUND ART

It is being considered to use a Long Term Evolution (LTE) network for a public safety network. The public safety network is a wireless communication network used for emergency services such as police, firefighting, and medical emergency, as well as highly public applications such as local governments and electric power, gas, and water utilities. The LTE system for public safety networks is called Public Safety LTE (PS-LTE). The Third Generation Partnership Project (3GPP) defines Mission Critical Push-to-Talk (MCPTT), which is one of the main features of PS-LTE (see, for example, Non-Patent Literature 1). The MCPTT architecture uses the aspects of the Group Communication System for LTE (GCSE_LTE) architecture, and also the aspects of the IP Multimedia Subsystem (IMS) architecture and the Proximity-based Services (ProSe) architecture. The GCSE_LTE enables group communication (see, for example, Non-Patent Literature 2).

It can be said that the PS-LTE network or system is a collection of hardware entities that provide applications, services, capabilities, and functions required to provide public safety services on an LTE network. The PS-LTE network or system may be a public LTE network (Public Land Mobile Network (PLMN)), a private LTE network, or a combination thereof.

The PS-LTE provides public safety services such as a PTT service. The PTT service is a Push To Talk communication service supporting applications for Mission Critical Organizations and for other businesses and organizations (e.g., public utilities and railways) with fast setup times, high availability, and reliability and priority handling. The public safety organizations include, for example, local police departments and local fire departments.

A user (e.g., PTT user) who uses a public safety service (e.g., PTT service) uses a wireless terminal or device (e.g., PS User Equipment (UE)) which has the capability to participate in the public safety service. Such devices (e.g., PS UE) allow users to participate in public safety services. Public safety service users include, for example, police officers and firefighters.

A public safety service provider is authorized to control parameters of the public safety service (e.g., PTT service) provided to a public safety organization. These parameters include, for example, user and group definition, user priorities, group membership/priorities/hierarchies, and security and privacy controls. A public safety service provider can also be referred to as a public safety service administrator.

The business relationships of public safety service users, public safety organizations, and public safety service providers are as follows. A public safety service user belongs to a single public safety organization based on a user agreement. The public safety organization receives a public safety service from a public safety service provider based on an agreement. The public safety service user can have a user contract and service arrangement direct with the public safety service provider. The public safety organization and the public safety service provider can be part of the same organization. Further or alternatively, the public safety service provider and the PS-LTE network operator can be part of the same organization.

### CITATION LIST

### Non Patent Literature

[Non Patent Literature 1] 3GPP TS 23.179 V13.5.0 (2017-03), “3rd Generation Partnership Project; Technical Specification Group Services and System Aspects; Functional architecture and information flows to support mission critical communication services; Stage 2 (Release 13)”, March 2017
[Non Patent Literature 2] 3GPP TS 23.468 V15.0.0 (2017-12), “3rd Generation Partnership Project; Technical Specification Group Services and System Aspects; Group Communication System Enablers for LTE (GCSE_LTE); Stage 2 (Release 15)”, December 2017

### SUMMARY OF INVENTION

### Technical Problem

A PS-LTE network or system that provides a public safety service requires priority handling at various levels regarding business relationships. Specifically, for example, priority handling between multiple public safety organizations, between multiple public safety service users (or devices (UEs)), and between multiple public safety service applications are needed. The multiple public safety service applications include, for example, a PTT application, a push-to-video application, a voice call application, a video call application, and an instant messaging application.

On the other hand, in an LTE network, QoS parameters such as Quality of Service (QoS) Class Identifier (QCI) and Allocation and Retention Priority (ARP) are used. The LTE QoS parameters, including QCI and ARP, are applied to a communication path provided by the LTE network to forward user traffic (i.e., Internet Protocol (IP) flows or IP packets) regarding communication between an application running on a UE and an external network (e.g., PS server). The communication path provided by the LTE network is, for example, an Evolved Packet System (EPS) bearer, a Multimedia Broadcast Multicast Service (MBMS) bearer, or a service data flow (SDF).

In order to provide a public safety service in an LTE network, it is necessary to reflect the priority handling of the above-mentioned various layers in an LTE QoS parameter. One of the objects to be attained by embodiments disclosed herein is to provide apparatuses, methods, and programs that contribute to reflecting priority handling regarding public safety services in a QoS parameter of a cellular communication network. It should be noted that this object is merely one of the objects to be attained by the embodiments disclosed herein. Other objects or problems and novel features will be made apparent from the following description and the accompanying drawings.

### Solution to Problem

In a first aspect, a system includes at least one server. The at least one server is configured to communicate with one or more applications running on each of a plurality of wireless terminals through one or more communication paths provided by a cellular communication network. In addition, the at least one server is configured to determine a quality of service (QoS) parameter to be applied by the cellular communication network to each of the one or more communication paths, based on one or any combination of an application priority associated with each application, a device priority associated with each wireless terminal, and an organization priority associated with an organization to which the plurality of wireless terminals belong. Furthermore, the at least one server is configured to communicate with a node in the cellular communication network to enforce the determined QoS parameter on the corresponding communication path.

In a second aspect, a method performed by a system, including at least one server, includes:
(a) communicating with one or more applications running on each of a plurality of wireless terminals through one or more communication paths provided by a cellular communication network;
(b) determining a quality of service (QoS) parameter to be applied by the cellular communication network to each of the one or more communication paths, based on one or any combination of an application priority associated with each application, a device priority associated with each wireless terminal, and an organization priority associated with an organization to which the plurality of wireless terminals belong; and
(c) communicating with a node in the cellular communication network to enforce the determined QoS parameter on the corresponding communication path.

In a third aspect, a program includes instructions (software codes) that, when loaded into a computer, cause the computer to perform the method according to the above-described second aspect.

### Advantageous Effects of Invention

According to the above-described aspects, it is possible to provide apparatuses, methods, and programs that contribute to reflecting priority handling regarding public safety services in a QoS parameter of a cellular communication network.

### BRIEF DESCRIPTION OF DRAWINGS

FIG. 1 is a block diagram showing a configuration example of a cellular communication network according to embodiments;

FIG. 2 is a block diagram showing a configuration example of a network platform according to embodiments;

FIG. 3 is a flowchart showing an example of operation of a network platform according to a first embodiment;

FIG. 4 is a flowchart showing an example of operation of a network platform according to a second embodiment;

FIG. 5 is a flowchart showing an example of operation of a network platform according to a third embodiment;

FIG. 6 is a flowchart showing an example of operation of a network platform according to a fourth embodiment;

FIG. 7 is a block diagram showing a configuration example of a server according to embodiments; and

FIG. 8 is a block diagram showing a configuration example of a wireless terminal according to embodiments.

### DESCRIPTION OF EMBODIMENTS

Specific embodiments will be described hereinafter in detail with reference to the drawings. The same or corresponding elements are denoted by the same symbols throughout the drawings, and duplicated explanations are omitted as necessary for the sake of clarity.

### First Embodiment

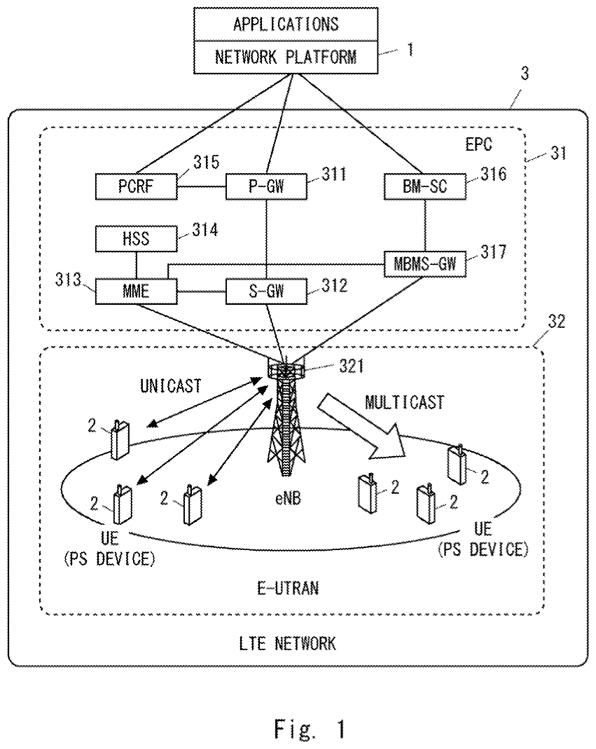

FIG. 1 shows a configuration example of a PS-LTE network or system according to embodiments including the present embodiment. The PS-LTE network or system provides one or more public safety services (e.g., a PTT service). In the example of FIG. 1, the PS-LTE network includes a network platform 1 and an LTE network 3. The network platform 1 communicates with one or more applications (e.g., a PTT client application and a Session Initiation Protocol (SIP) client application) running on each of a plurality of wireless terminals (UEs) 2 through one or more communication paths provided by the LTE network 3. In other words, the network platform 1 includes a plurality of functional entities in the application domain and communicates with the UEs 2 on the application layer (or application service layer). The UEs 2 are also referred to as public safety devices.

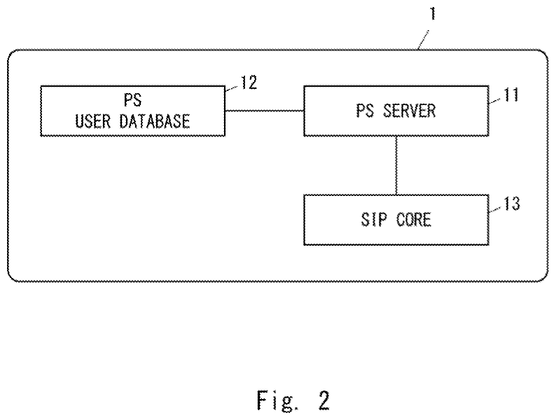

The network platform 1 includes one or more servers. Each server included in the network platform 1 may be one or more computers. For example, as shown in FIG. 2, the network platform 1 may include a PS server 11, a PS user database 12, and a SIP core 13. The PS server 11 provides centralized support for a PS service (e.g., PTT service, push-to-video service). More specifically, the PS server 11 is responsible for, for example, PS user authentication, keeping tracking of the locations of the UEs 2 (PS UEs), and requesting the allocation of resources in the cellular communication network to the UEs 2. The PS server 11 may include the functions of a GCS application server (AS). The PS user database 12 stores information of PS user profiles. The PS user profile are determined by a public safety organization, a public safety service provider, and potentially a public safety service user. The SIP core 13 is in charge of SIP registration, establishes a SIP signaling bearer, and sends and receives SIP signaling messages to and from each UE 2 (SIP client on each UE 2). The PS user database 12 may be a device outside the network platform 1.

Further or alternatively, the network platform 1 may include other servers. The network platform 1 may include, for example, but not limited to, a GCS application server (AS) and/or a SIP database. The GCS AS uses an EPS bearer service or an MBMS bearer service, performing transfer or delivery of application signaling and application data to a group of UEs. The SIP database stores SIP subscriber information (SIP subscriptions) and authentication information that are required by the SIP core 13.

The LTE network 3 includes a core network (i.e., Evolved Packet Core (EPC)) 31 and a radio access network (i.e., Evolved Universal Terrestrial Radio Access Network (E-UTRAN)) 32. The EPC 31 includes a plurality of nodes, which include a plurality of control plane nodes and a plurality of user plane (or data plane) nodes. One or more nodes in the EPC 31 may have both control plane and user plane functions. For example, as shown in FIG. 1, the EPC 31 may include a Packet Data Network Gateway (P-GW) 311, a Serving Gateway (S-GW) 312, a Mobility Management Entity 313, a Home Subscriber Server (HSS) 314, a Policy and Charging Rules Function (PCRF) 315, a Broadcast Multicast Service Center (BM-SC) 316, and an MBMS Gateway (MBMS GW) 317. The E-UTRAN 32 includes a base station (eNodeB (eNB)) 321. Of course, although not explicitly shown in FIG. 1, the EPC 31 may include a plurality of S-GWs 312, and the E-UTRAN 32 may include a plurality of eNBs 321.

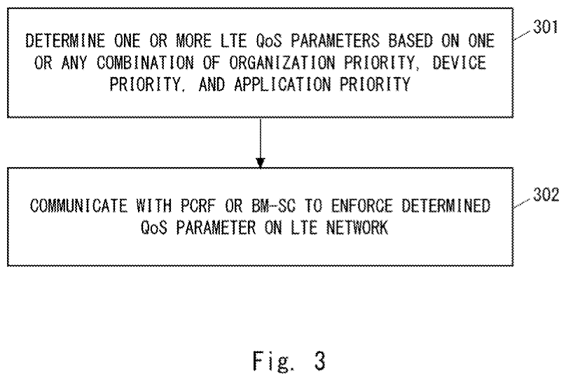

FIG. 3 shows an example of an operation of the network platform 1 according to the present embodiment. The operation shown in FIG. 3 may be performed by a single server (e.g., the PS server 11) in the network platform 1 or by a plurality of servers (e.g., the PS server 11 and the PS user database 12).

In step 301, the network platform 1 determines an LTE QoS parameter to be applied by the LTE network 3 to each communication path (e.g., EPS bearer, MBMS bearer, or SDF), based on one or any combination of an organization priority, a device priority, and an application priority.

The organization priority is a priority (or priority level) of each of a plurality of public safety organizations (e.g., local police departments and multiple local fire departments) that use a public safety service provided by the PS-LTE network. The organization priority is used for priority handling among these multiple public safety organizations.

The device priority is a priority (or priority level) of each UE 2 used by each user belonging to a single public safety organization. The device priority is used for priority handling among multiple UEs 2.

The application priority is a priority (or priority level) of each public safety service application executed on each UE 2 (or of each application service provided to each UE 2). The application priority is used for priority handling among multiple applications. The multiple public safety service applications include, for example, any combination of a PTT application, a push-to-video application, a voice call application, a video call application, and an instant messaging application.

The LTE QoS parameter includes, for example, a QCI, an ARP, or both. The QCI represents a priority level of an EPS bearer, an SDF, or each IP packet that makes up an IP flow transferred by them. The QCI is an integer from 1 to 9. For example, QCI value “1” may be associated with the highest priority level. Meanwhile, the ARP is considered when a new EPS bearer is created. Specifically, when a new EPS bearer is needed in the LTE network with insufficient resources, an LTE entity (e.g., P-GW 311, S-GW 312, or eNB 321) considers the ARP values of both the existing EPS bearers and the new EPS bearer, and either creates the new EPS bearer by deleting one of the existing EPS bearers or rejects the creation of the new EPS bearer. The ARP is an integer from 1 to 15. For example, ARP value “1” may be associated with the highest priority level.

Preferably, the network platform 1 may determine the LTE QoS parameter using at least two of the organization priority, the device priority, and the application priority. In this case, the multiple priorities considered may be weighted by different factors from each other.

In one example, the LTE QoS parameter may be derived by the following formula (1):

$$U = ⌊ \frac{aX + bY + cZ}{{X}_{m} + {Y}_{m} + {Z}_{m}} {U}_{m} ⌋ , \qquad ( 1 )$$

where U is the QoS parameter, X is the organization priority, Y is the device priority, Z is the application priority, Uₘ is the maximum value of the QoS parameter, Xₘ is the maximum value of the organization priority, Yₘ is the maximum value of the device priority, Zₘ is the maximum value of the application priority, and a, b, and c are each weighting factors each between 0 to 1.

The organization priority X, the device priority Y, the application priority Z, and the LTE QoS parameter U may be defined so that the minimum value (for example, 1) is associated with the highest priority level. In this case, for example, the more important the organization priority X is, the smaller the value of the weighting factor “a” of the organization priority X. The weighting factor “b” of the device priority Y and the weighting factor “c” of the application priority Z may be defined in the same manner as the weighting factor “a” of the organization priority X.

In some implementations, the network platform 1 may acquire the organization priority, the device priority, and the application priority from the server (e.g., PS user database 12) that manages information on public safety service users.

Returning to FIG. 3, in step 302, the network platform 1 communicates with a node (e.g., PCRF or BM-SC) in the LTE network 3 to enforce the LTE QoS parameter determined in step 301 on the corresponding communication path (e.g., EPS bearer, MBMS bearer, or SDF).

According to the above-described operations, the network platform 1 allows one or any combination of the organization priority, the device priority, and the application priority, which are related to the public safety service, to be reflected in the QoS parameter (e.g., QCI or ARP) of the LTE network 3.

### Second Embodiment

The present embodiment provides a modified example of the operations of the network platform 1 described in the first embodiment. A configuration example of a PS-LTE network according to the present embodiment is the same as that shown in FIGS. 1 and 2. In this embodiment, the network platform 1 is configured to dynamically change at least one of an application priority, a device priority, and an organization priority depending on a load of the LTE network 3, thereby updating an LTE QoS parameter.

The load of the LTE network 3 may be a load of the E-UTRAN 32 or a load of the EPC 31. The load of the E-UTRAN 32 may be a load of the eNB 321 or a load on any cell provided by the eNB 321. The load of the E-UTRAN 32 may be related to the number of UEs of the eNB 321 or the cell, the number of connections (e.g., Radio Resource Control (RRC) connections) of the eNB 321 or the cell, or a radio resource usage amount (or rate) in the eNB 321 or the cell. The load of the EPC 31 may be a load of any EPC node (e.g., MME 313, P-GW 311). The load of the EPC 31 may be related to the number of UEs associated with the EPC node, the number of connections (e.g., PDN connections) associated with the EPC node, or the amount of user traffic associated with the EPC node.

The network platform 1 may acquire the load of the LTE network 3 from, for example, a monitoring system (e.g., an Element Management System (EMS)) of the LTE network 3.

In one example, the network platform 1 may update at least one of the application priority, the device priority, and the organization priority, so as to reduce a load of a heavily loaded cell, eNB, or EPC node. More specifically, for example, the network platform 1 may lower the priority of an application (e.g., video call application) that require a relatively high data rate when the EPC node is under heavy load. Additionally or alternatively, the network platform 1 may lower the device priority of UEs 2 located in a cell when the cell is under heavy load. Additionally or alternatively, the network platform 1 may adjust the organization priority of one or more public safety organizations utilizing the eNB 321 when the eNB 321 is under heavy load.

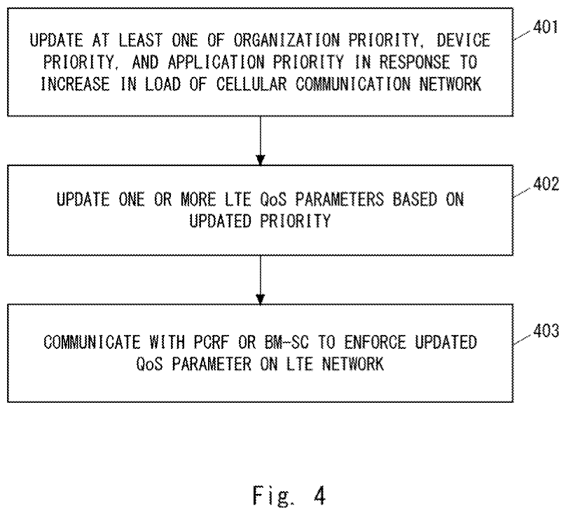

FIG. 4 shows an example of an operation of the network platform 1 according to the present embodiment. The operation shown in FIG. 4 may be performed by a single server (e.g., the PS server 11) in the network platform 1 or by a plurality of servers (e.g., the PS server 11 and the PS user database 12).

In step 401, the network platform 1 updates at least one of the organization priority, the device priority, and the application priority in response to an increase in a load of the LTE network 3. In step 402, the network platform 1 updates one or more LTE QoS parameters based on the updated priority(ies). The calculation of the LTE QoS parameter(s) in step 402 may be performed according to the method described in the first embodiment. In step 403, the network platform 1 communicates with a node (e.g., PCRF or BM-SC) in the LTE network 3 to apply the LTE QoS parameter(s) determined (or updated) in step 402 to the corresponding communication path (e.g., EPS bearer, MBMS bearer, or SDF).

According to the above operation, the network platform 1 can dynamically change at least one of the organization priority, the device priority, and the application priority according to a load of the LTE network 3, thereby dynamically updating a QoS parameter (e.g., QCI or ARP) to be imposed on the LTE network 3.

### Third Embodiment

The present embodiment provides a modified example of the operation of the network platform 1 described in the first embodiment. A configuration example of a PS-LTE network according to the present embodiment is the same as that shown in FIGS. 1 and 2.

In this embodiment, the network platform 1 is configured to dynamically change at least one of an application priority, a device priority, and an organization priority in response to an occurrence of a disaster event, thereby updating an LTE QoS parameter. The disaster event may be, for example, an earthquake, a volcanic eruption, a flood, a tornado, a tsunami, or a large fire.

In some implementations, the network platform 1 may receive a message indicating an occurrence of a disaster event from another server or from any application.

In one example, the network platform 1 may adjust the organization priority of one or more public safety organizations so that the organization priority of a particular public safety organization associated with the disaster event that has occurred is relatively high. Additionally or alternatively, the network platform 1 may adjust the application priority of one or more applications so that the application priority of a particular application associated with the disaster event that occurred is relatively high. Additionally or alternatively, the network platform 1 may adjust the device priority of one or more UEs 2 so that the device priority of UEs 2 located in the area of the disaster event that occurred is relatively high.

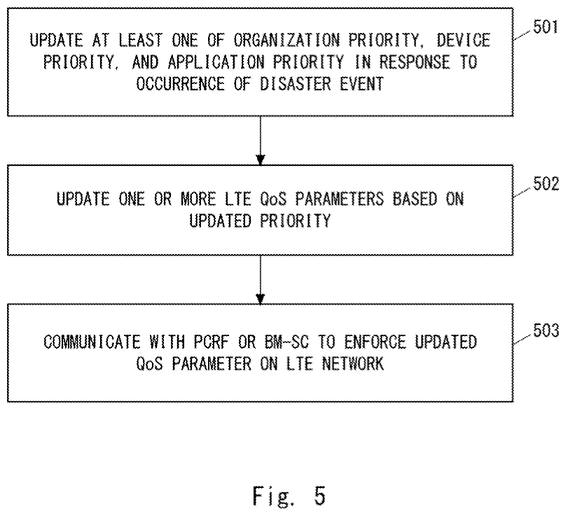

FIG. 5 shows an example of an operation of the network platform 1 according to the present embodiment. The operation shown in FIG. 5 may be performed by a single server (e.g., the PS server 11) in the network platform 1 or by a plurality of servers (e.g., the PS server 11 and the PS user database 12).

In step 501, the network platform 1 updates at least one of the organization priority, the device priority, and the application priority in response to an occurrence of a disaster event. In step 502, the network platform 1 updates one or more LTE QoS parameters based on the updated priority. The calculation of the LTE QoS parameter(s) in step 502 may be performed according to the method described in the first embodiment. In step 503, the network platform 1 communicates with a node (e.g., PCRF or BM-SC) in the LTE network 3 to apply the LTE QoS parameter(s) determined (or updated) in step 502 to the corresponding communication path (e.g., EPS bearer, MBMS bearer, or SDF).

According to the above operation, the network platform 1 can dynamically change at least one of the organization priority, the device priority, and the application priority in response to an occurrence of a disaster event, thereby dynamically changing a QoS parameter (e.g., QCI or ARP) to be imposed on the LTE network 3.

### Fourth Embodiment

The present embodiment provides a modified example of the operations of the network platform 1 described in the first to third embodiments. A configuration example of a PS-LTE network according to the present embodiment is the same as that shown in FIGS. 1 and 2.

In this embodiment, the network platform 1 may change at least one of an application priority, a device priority, and an organization priority, in response to an occurrence of an event that is different from events regarding a load of the LTE network 3 and from disaster events.

Additionally or alternatively, the network platform 1 may change a rule or calculation formula for deriving an LTE QoS parameter from one or any combination of the application priority, the device priority, and the organization priority, in response to an occurrence of a predetermined event. The predetermined event may be an event related to a load of the LTE network 3 (e.g., load increase or decrease), a disaster event, or another event different from these.

In one example, the network platform 1 may update at least one of the weighting factors “a”, “B”, and “c” contained in the formula (1) described in the first embodiment in response to the occurrence of a predetermined event.

Further or alternatively, the network platform 1 may exclude at least one of the application priority, the device priority, and the organization priority from the rule or calculation formula for deriving the LTE QoS parameter, in response to the occurrence of a predetermined event.

Further or alternatively, in response to an occurrence of a predetermined event, the network platform 1 may derive the LTE QoS parameter by using a rule or calculation formula that do not consider low application priority levels (e.g., the lowest priority level). For example, in the above-described calculation formula (1), the maximum value Zₘ of the application priority may be replaced with Zₘ₋₁.

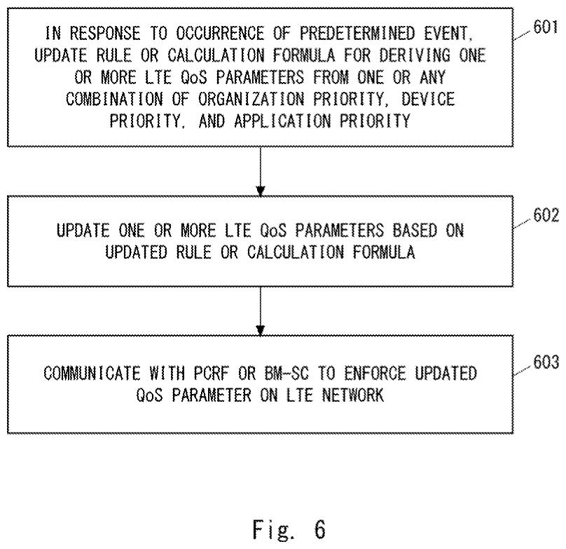

FIG. 6 shows an example of an operation of the network platform 1 according to the present embodiment. The operation shown in FIG. 6 may be performed by a single server (e.g., the PS server 11) in the network platform 1 or by a plurality of servers (e.g., the PS server 11 and the PS user database 12).

In step 601, in response to an occurrence of a predetermined event, the network platform 1 updates a rule or calculation formula for deriving one or more LTE QoS parameters from one or any combination of the application priority, the device priority, and the organization priority. In step 602, the network platform 1 updates one or more LTE QoS parameters based on the updated rule or formula. The calculation of the LTE QoS parameter(s) in step 602 may be performed according to the method described in the first embodiment. In step 603, the network platform 1 communicates with a node (e.g., PCRF or BM-SC) to enforce the LTE QoS parameter(s) determined (or updated) in step 602 on the corresponding communication path (e.g., EPS bearer, MBMS bearer, or SDF).

According to the above operation, the network platform 1 can change the rule or calculation formula for deriving an LTE QoS parameter(s) in response to the occurrence of a predetermined event, thereby dynamically changing the QoS parameter(s) (e.g., QCI or ARP) to be imposed on the LTE network 3.

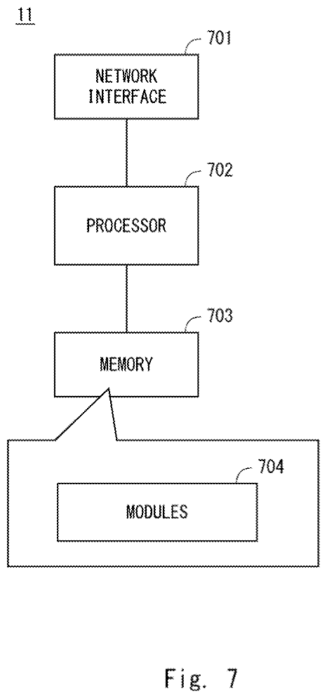

The following provides configuration examples of the one or more servers in the network platform 1, and the UE 2 according to the above-described embodiments. FIG. 7 is a block diagram showing a configuration example of the PS server 11. The configurations of the other servers in the network platform 1 may be similar to that shown in FIG. 7. Referring to FIG. 7, the PS server 11 includes a network interface 701, a processor 702, and a memory 703. The network interface 701 is used to communicate with other servers (e.g., PS user database 12 and the SIP core 13) in the network platform 1, nodes (e.g., the P-GW 311, the PCRF 315, and the BM-SC 316) in the EPC 31, and other nodes. The network interface 701 may include, for example, a network interface card (NIC) conforming to the IEEE 802.3 series.

The processor 702 loads and executes software (computer programs) from the memory 703, thereby performing the processing of the PS server 11 described in the above embodiments. The processor 702 may be, for example, a microprocessor, a Micro Processing Unit (MPU), or a Central Processing Unit (CPU). The processor 702 may include a plurality of processors.

The memory 703 is composed of a volatile memory and a nonvolatile memory. The volatile memory is, for example, a Static Random-Access Memory (SRAM), a Dynamic RAM (DRAM), or a combination thereof. The non-volatile memory is, for example, a Mask Read Only Memory (MROM), an Electrically Erasable Programmable ROM (EEPROM), a flash memory, a hard disc drive, or any combination thereof. The memory 703 may include a storage located apart from the processor 702. In this case, the processor 702 may access the memory 703 via the network interface 701 or an I/O interface (not illustrated).

The memory 703 may store one or more software modules (computer programs) 704 including instructions and data to perform the processing of the PS server 11 described in the above embodiments. In some implementations, the processor 702 may be configured to load the one or more software modules 704 from the memory 703 and execute the loaded software modules, thereby performing the processing of the PS server 11 described in the above embodiments.

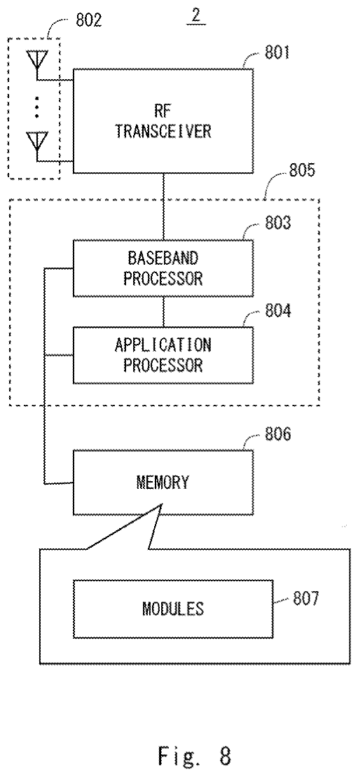

FIG. 8 is a block diagram showing a configuration example of the UE 2. A Radio Frequency (RF) transceiver 801 performs analog RF signal processing to communicate with the gNB 321. The RF transceiver 801 may include a plurality of transceivers. The analog RF signal processing performed by the RF transceiver 801 includes frequency up-conversion, frequency down-conversion, and amplification. The RF transceiver 801 is coupled to an antenna array 802 and a baseband processor 803. The RF transceiver 801 receives modulated symbol data (or OFDM symbol data) from the baseband processor 803, generates a transmission RF signal, and supplies the transmission RF signal to the antenna array 802. The RF transceiver 801 also generates a baseband received signal based on a received RF signal received by the antenna array 802 and supplies the baseband received signal to the baseband processor 803. The RF transceiver 801 may include an analog beamformer circuit for beam forming. The analog beamformer circuit includes, for example, a plurality of phase shifters and a plurality of power amplifiers.

The baseband processor 803 performs digital baseband signal processing (i.e., data-plane processing) and control-plane processing for radio communication. The digital baseband signal processing includes, for example, (a) data compression/decompression, (b) data segmentation/concatenation, (c) composition/decomposition of a transmission format (i.e., transmission frame), (d) channel coding/decoding, (e) modulation (i.e., symbol mapping)/demodulation, and (f) generation of OFDM symbol data (i.e., baseband OFDM signal) by Inverse Fast Fourier Transform (IFFT). Meanwhile, the control-plane processing includes communication management of layer 1 (e.g., transmission power control), layer 2 (e.g., radio resource management and hybrid automatic repeat request (HARQ) processing), and layer 3 (e.g., signaling regarding attach, mobility, and call management).

The digital baseband signal processing by the baseband processor 803 may include, for example, signal processing of a Packet Data Convergence Protocol (PDCP) layer, a Radio Link Control (RLC) layer, a Medium Access Control (MAC) layer, and a Physical (PHY) layer. The control-plane processing performed by the baseband processor 803 may include processing of Non-Access Stratum (NAS) protocols, Radio Resource Control (RRC) protocols, and MAC Control Elements (CEs).

The baseband processor 803 may perform MIMO encoding and pre-coding for beam forming.

The baseband processor 803 may include a modem processor (e.g., Digital Signal Processor (DSP)) that performs the digital baseband signal processing and a protocol stack processor (e.g., a CPU or an MPU) that performs the control-plane processing. In this case, the protocol stack processor, which performs the control-plane processing, may be integrated with an application processor 804 described in the following.

The application processor 804 is also referred to as a CPU, an MPU, a microprocessor, or a processor core. The application processor 804 may include a plurality of processors (processor cores). The application processor 804 loads a system software program (Operating System (OS)) and various application programs (e.g., a call application, a WEB browser, a mailer, a camera operation application, and a music player application) from a memory 806 or from another memory (not illustrated) and executes these programs, thereby providing various functions of the UE 2.

In some implementations, as represented by a dashed line (805) in FIG. 8, the baseband processor 803 and the application processor 804 may be integrated on a single chip. In other words, the baseband processor 803 and the application processor 804 may be implemented in a single System on Chip (SoC) device 805. An SoC device may be referred to as a Large-Scale Integration (LSI) or a chipset.

The memory 806 is a volatile memory, a non-volatile memory, or a combination thereof. The memory 806 may include a plurality of memory devices that are physically independent from each other. The volatile memory is, for example, an SRAM, a DRAM, or a combination thereof. The non-volatile memory is, for example, an MROM, an EEPROM, a flash memory, a hard disc drive, or any combination thereof. The memory 806 may include, for example, an external memory device that can be accessed from the baseband processor 803, the application processor 804, and the SoC 805. The memory 806 may include an internal memory device that is integrated in the baseband processor 803, the application processor 804, or the SoC 805. The memory 806 may also include a memory in a Universal Integrated Circuit Card (UICC).

The memory 806 may store one or more software modules (computer programs) 807 including instructions and data to perform the processing by the UE 2 described in the above embodiments. In some implementations, the baseband processor 803 or the application processor 804 may load these software modules 807 from the memory 806 and execute the loaded software modules, thereby performing the processing of the UE 2 described in the above embodiments with reference to the drawings.

The control-plane processing and operations performed by the UE 2 described in the above embodiments can be achieved by elements other than the RF transceiver 801 and the antenna array 802, i.e., achieved by the memory 806, which stores the software modules 807, and one or both of the baseband processor 803 and the application processor 804.

As described above with reference to FIGS. 7 and 8, each of the processors that the server (e.g., the PS server 11) and the UE 2 according to the above embodiments include executes one or more programs including instructions for causing a computer to execute an algorithm described with reference to the drawings. These programs can be stored and provided to a computer using any type of non-transitory computer readable media. Non-transitory computer readable media include any type of tangible storage media. Examples of non-transitory computer readable media include magnetic storage media (such as flexible disks, magnetic tapes, hard disk drives, etc.), optical magnetic storage media (e.g., magneto-optical disks), Compact Disc Read Only Memory (CD-ROM), CD-R, CD-R/W, and semiconductor memories (such as mask ROM, Programmable ROM (PROM), Erasable PROM (EPROM), flash ROM, Random Access Memory (RAM), etc.). These programs may be provided to a computer using any type of transitory computer readable media. Examples of transitory computer readable media include electric signals, optical signals, and electromagnetic waves. Transitory computer readable media can provide the programs to a computer via a wired communication line (e.g., electric wires, and optical fibers) or a wireless communication line.

### Other Embodiments

Each of the above-described embodiments may be used individually or two or more embodiments may be appropriately combined with one another.

The above-described embodiments have been described mainly for LTE systems (i.e., PS-LTE systems) that provide one or more public safety services. However, these embodiments may be applied to public safety systems that use cellular communication networks other than LTE.

Furthermore, the above-described embodiment may be applied to a public safety system using a plurality of cellular communication networks of the same type or different types. In one example, one of the cellular communication networks may be a private cellular communication network and another one may be a public cellular communication network. Further or instead, one of the cellular communication networks may be an LTE network and another one may be a non-LTE cellular communication network.

The above-described embodiments are merely examples of applications of the technical ideas obtained by the inventor. These technical ideas are not limited to the above-described embodiments and various modifications can be made thereto.

This application is based upon and claims the benefit of priority from Japanese Patent Application No. 2019-055092, filed on Mar. 22, 2019, the disclosure of which is incorporated herein in its entirety by reference.

### REFERENCE SIGNS LIST

1 Network Platform
2 UE
3 LTE Network
11 PS Server
12 PS User Database
13 SIP Core
31 EPC
32 E-UTRAN
702 Processor
703 Memory
803 Baseband Processor
804 Application Processor
806 Memory

What is claimed is:

1. A system comprising:
at least one server configured to:
communicate with one or more applications running on each of a plurality of wireless terminals through one or more communication paths provided by a cellular communication network;
determine a quality of service (QoS) parameter to be applied by the cellular communication network to each of the one or more communication paths, based on one or any combination of an application priority associated with each application, a device priority associated with each wireless terminal, and an organization priority associated with an organization to which the plurality of wireless terminals belong; and
communicate with a node in the cellular communication network to enforce the determined QoS parameter on the corresponding communication path.

2. The system according to claim 1, wherein the at least one server is configured to determine the QoS parameter by using at least two of the application priority, the device priority, and the organization priority.

3. The system according to claim 1, wherein the at least one server is configured to update at least one of the application priority, the device priority, and the organization priority, depending on a load of the cellular communication network, thereby updating the QoS parameter.

4. The system according to claim 1, wherein the at least one server is configured to update a rule or a calculation formula for deriving the QoS parameter from one or any combination of the application priority, the device priority, and the organization priority, depending on a load of the cellular communication network, thereby updating the QoS parameter.

5. The system according to claim 1, wherein the at least one server is configured to update at least one of the application priority, the device priority, and the organization priority in response to an occurrence of a predetermined event, thereby updating the QoS parameter.

6. The system according to claim 1, wherein the at least one server is configured to update a rule or a calculation formula for deriving the QoS parameter from one or any combination of the application priority, the device priority, and the organization priority, in response to an occurrence of a predetermined event, thereby updating the QoS parameter.

7. The system according to claim 1, wherein the at least one server comprises one or any combination of a Push to Talk (PTT) server, a Session Initiation Protocol (SIP) server, and a Group Communication System Application Server (GCS AS).

8. The system according to claim 1, wherein the cellular communication network is a Public Safety Long Term Evolution (PS-LTE) network.

9. The system according to claim 8, wherein the at least one server is configured to update at least one of the application priority, the device priority, and the organization priority in response to an occurrence of a disaster event, thereby updating the QoS parameter.

10. The system according to claim 8, wherein the at least one server is configured to update a rule or a calculation formula for deriving the QoS parameter from one or any combination of the application priority, the device priority, and the organization priority, in response to an occurrence of a disaster event, thereby updating the QoS parameter.

11. A method performed by a system comprising at least one server, the method comprising:
communicating with one or more applications running on each of a plurality of wireless terminals through one or more communication paths provided by a cellular communication network;
determining a quality of service (QoS) parameter to be applied by the cellular communication network to each of the one or more communication paths, based on one or any combination of an application priority associated with each application, a device priority associated with each wireless terminal, and an organization priority associated with an organization to which the plurality of wireless terminals belong; and
communicating with a node in the cellular communication network to enforce the determined QoS parameter on the corresponding communication path.

12. The method according to claim 11, wherein said determining includes determining the QoS parameter by using at least two of the application priority, the device priority, and the organization priority.

13. The method according to claim 11, further comprising updating at least one of the application priority, the device priority, and the organization priority, depending on a load of the cellular communication network, thereby updating the QoS parameter.

14. The method according to claim 11, further comprising updating a rule or a calculation formula for deriving the QoS parameter from one or any combination of the application priority, the device priority, and the organization priority, depending on a load of the cellular communication network, thereby updating the QoS parameter.

15. The method according to claim 11, further comprising updating at least one of the application priority, the device priority, and the organization priority in response to an occurrence of a predetermined event, thereby updating the QoS parameter.

16. The method according to claim 11, further comprising updating a rule or a calculation formula for deriving the QoS parameter from one or any combination of the application priority, the device priority, and the organization priority, in response to an occurrence of a predetermined event, thereby updating the QoS parameter.

17. The method according to claim 11, wherein the at least one server comprises one or any combination of a Push to Talk (PTT) server, a Session Initiation Protocol (SIP) server, and a Group Communication System Application Server (GCS AS).

18. The method according to claim 11, wherein the cellular communication network is a Public Safety Long Term Evolution (PS-LTE) network.

19. The method according to claim 18, further comprising updating at least one of the application priority, the device priority, and the organization priority in response to an occurrence of a disaster event, thereby updating the QoS parameter.

20. The method according to claim 18, further comprising updating a rule or a calculation formula for deriving the QoS parameter from one or any combination of the application priority, the device priority, and the organization priority, in response to an occurrence of a disaster event, thereby updating the QoS parameter.
